(19) United States
(12) Patent Application Publication
(10) Pub. No.: US 2013/0076296 A1
(43) Pub. Date: Mar. 28, 2013

(54) CHARGING APPARATUS

(71) Applicant: Sadatoshi Ushiroda, Nagoya-shi (JP)

(72) Inventor: Sadatoshi Ushiroda, Nagoya-shi (JP)

(73) Assignee: TOYOTA JIDOSHA KABUSHIKI KAISHA, Toyota-shi, Aichi-ken (JP)

(21) Appl. No.: 13/700,284

(22) PCT Filed: May 27, 2011
(86) PCT No.: PCT/IB2011/001143

§ 371 Date: Nov. 27, 2012

(30) Foreign Application Priority Data
May 31, 2010 (JP) 2010-125361

(51) Int. Cl. H02J 7/00

(52) U.S. Cl. CPC H02J 7/0057
USPC 320/101; 320/109

(57) ABSTRACT

A charging apparatus charges a secondary battery of a vehicle by moving an electric power supplying portion along a transverse groove and a longitudinal groove to a position that enables electric power to be supplied to a parked vehicle, and then supplying electric power to the vehicle from the electric power supplying portion, each time a vehicle is parked in a parking space of a parking lot, when the parked vehicle is an authorized vehicle and a state of charge of the secondary battery is equal to or less than a predetermined value.

### BACKGROUND OF THE INVENTION

1. Field of the Invention

The invention relates to a charging apparatus, and more particularly, to a charging apparatus arranged in a parking lot provided with parking spaces for a plurality of vehicles.

2. Description of Related Art

In recent years, hybrid vehicles that are provided with a secondary battery and use an engine and an electric motor as power sources have come to be widespread in an attempt to reduce CO₂ and the like. Electric vehicles that are provided with a secondary battery and use only an electric motor as the power source are also receiving a lot of attention for the same reason. Also, while charging of the secondary battery in a hybrid vehicle is performed using electric power generated mainly by the engine, plug-in vehicles (so-called plug-in hybrid vehicles) in which the secondary battery is also able to be charged with electric power from an external power supply such as a commercial power source supplied by a power company, for example, are being considered in order to further reduce CO₂. With electric vehicles as well, secondary batteries that can be charged using a commercial power supply or the like are being considered because charging facilities are not yet widely spread as infrastructure.

Japanese Patent Application Publication No. 9-102329 (JP-A-9-102329) describes an electric vehicle charging system that includes a primary coil, a secondary coil, vehicle position detecting means, and a charging control circuit. The primary coil is provided on the parking lot side and is connected to a power source used for charging. The secondary coil is provided in the electric vehicle and is connected to a charging circuit that leads to a power storage device. The vehicle position detecting means detects when both coils are in positions where magnetic coupling is possible. The charging control circuit energizes the primary coil with the power source for charging when the vehicle position detecting means has detected that the electric vehicle is in a predetermined position and an identification code sent from the electric vehicle matches a pre-stored identification code.

However, when the technology described in JP-A-9-102329 is used to charge a vehicle parked in a parking lot provided with parking spaces for a plurality of vehicles, the same number of charging systems described in JP-A-9-102329 as the number of vehicles that can be parked in the parking lot must be provided in order to be able to charge a parked vehicle regardless of which parking space of the parking lot the vehicle is parked in. As a result, the structure becomes extremely complex as well as costly.

### SUMMARY OF THE INVENTION

The invention thus provides a charging apparatus capable of charging a parked vehicle regardless of which parking space of a parking lot that is provided with parking spaces for a plurality of vehicles the vehicle is parked in, with a simple structure.

A first aspect of the invention relates to a charging apparatus arranged in a parking lot provided with parking spaces for a plurality of vehicles. This charging apparatus includes i) at least one electric power supplying portion that is capable of supplying a vehicle parked in any one of the parking spaces with electric power for charging a secondary battery provided in the vehicle, while in a state in which a relative position of the electric power supplying portion with respect to the vehicle parked in one of the parking spaces is an electric power supplying position in which electric power can be supplied to the vehicle, and that is capable of moving between a plurality of first positions in which the relative position of the electric power supplying portion with respect to each vehicle, when a plurality of vehicles are parked in the plurality of parking spaces, parked in each of the parking spaces is the electric power supplying position, and a second position that is outside of a range in which that would interfere with a vehicle pulling into or out of the parking lot; ii) determining means for determining whether each vehicle parked in each parking space of the parking lot is an authorized vehicle that has been preregistered for the parking space in which the vehicle is parked; iii) detecting means for detecting a state of charge of the secondary battery for each vehicle parked in each parking space of the parking lot; and iv) controlling means for, when it is determined by the determining means that the vehicle parked in a given parking space of the parking lot is the authorized vehicle of the given parking space and the state of charge of the secondary battery of the vehicle detected by the detecting means is equal to or less than a predetermined value, performing control such that the electric power supplying portion moves to the first position corresponding to the given parking space, from among the plurality of first positions, and electric power is supplied by the electric power supplying portion to the vehicle parked in the given parking space.

The charging apparatus according to the aspect described above includes at least one electric power supplying portion that is arranged in a parking lot provided with parking spaces for a plurality of vehicles, is capable of supplying a vehicle with electric power for charging a secondary battery provided in the vehicle, while in a state in which a relative position of the electric power supplying portion with respect to the vehicle is an electric power supplying position. Moreover, the charging apparatus moves between a plurality of first positions in which the relative position of the electric power supplying portion with respect to each vehicle, when a plurality of vehicles are parked in the plurality of parking spaces, parked in each of the parking spaces is the electric power supplying position, and a second position that is outside of a range in which that would interfere with a vehicle pulling into or out of the parking lot. As a result, the electric power supplying portion is able to supply electric power to a vehicle parked in any of the parking spaces for a plurality of vehicles provided in the parking lot, by moving to the corresponding first position.

Also, the charging apparatus according to the aspect described above includes determining means for determining whether each vehicle parked in each parking space of the parking lot is an authorized vehicle that has been preregistered for the parking space in which the vehicle is parked, and detecting means for detecting a state of charge of the secondary battery for each vehicle parked in each parking space of the parking lot. When it is determined by the determining means that the vehicle parked in a given parking space of the parking lot is the authorized vehicle of the given parking space and the state of charge of the secondary battery of the vehicle detected by the detecting means is equal to or less than a predetermined value, the controlling means performs control such that the electric power supplying portion moves to the first position corresponding to the given parking space, from among the plurality of first positions, and electric power is supplied by the electric power supplying portion to the vehicle parked in the given parking space.

As a result, regardless of which of the parking spaces of the parking lot the vehicle is parked in, as long as the vehicle that is parked is an authorized vehicle and the state of charge of the secondary battery is equal to or less than a predetermined value, the electric power supplying portion will be moved to the first position corresponding to the parking space in which the vehicle is parked, and electric power will be supplied to the parked vehicle. In this way, with the charging apparatus according to the aspect described above, the same number of electric power supplying portions that supply electric power to a vehicle as the number of parking spaces in the parking lot do not need to be provided. Therefore, it is possible to charge a parked vehicle, regardless of which parking space of a parking lot that is provided with parking spaces for a plurality of vehicles the vehicle is parked in, with a simple structure.

Also, in the charging apparatus according to the aspect described above may also include a car stop that be arranged in each of the parking spaces of the parking lot. Also the second position may be a space, in the parking space, that is opposite a space where the vehicle can park and that is separated from the space where the vehicle can park by the car stop.

Also, in the charging apparatus described above, the electric power supplying portion may include a base portion that can move within the parking lot, electric power supplying means that is mounted to the base portion, horizontal moving means for moving the base portion in a horizontal direction and changing a direction of movement of the base portion within a horizontal plane, and raising/lowering means for raising/lowering the electric power supplying means. Further, the controlling means may first control the horizontal moving means to move the base portion to a horizontal position according to the first position that corresponds to the given parking space in which the vehicle is parked, and then control the raising/lowering means to raise/lower the electric power supplying means to the first position.

By enabling the electric power supplying means to be raised and lowered in this way, the vehicle does not have to be configured such that the height position of the electric power supplying portion (i.e., the electric power supplying means) when the relative position of the vehicle and the electric power supplying portion is an electric power supplying position in which electric power can be supplied to the vehicle is fixed irrespective of the type of vehicle. Further, when moving the base portion in the horizontal direction, the electric power supplying means can be prevented from interfering with the vehicle by lowering the position of the electric power supplying means.

Also, in the charging apparatus described above, the state in which the relative position of the electric power supplying portion with respect to the vehicle parked in one of the parking spaces is the electric power supplying position may be a state in which the electric power supplying portion is in a position corresponding to an electric power receiving portion of the vehicle that is provided in a position offset to one end side in a vehicle longitudinal direction with respect to a center portion of the vehicle. Also, the electric power supplying portion may move in a horizontal direction along a movement guiding portion arranged in the parking lot, and the movement guiding portion may be arranged along a section that extends from the second position to at least a position corresponding to the electric power receiving portion of the vehicle in one of the parking spaces when the vehicle is parked in the parking space of the parking lot while facing a first direction in which an end portion on the one end side in the vehicle longitudinal direction on which the electric power receiving portion is provided is closer to the second position than the end portion on the other end side. Further, with at least one of the parking spaces for a plurality of vehicles, the movement guiding portion may extend to a position corresponding to the electric power receiving portion of the vehicle in one of the parking spaces when the vehicle is parked in the parking space while facing a second direction that is opposite the first direction.

In the charging apparatus described above, the electric power supplying portion moves in the horizontal direction along the movement guiding portion that is arranged in the parking lot. Incidentally, the movement guiding portion may be formed by a long groove or a mark or the like. If the movement guiding portion is formed by a long groove, the electric power supplying portion may include a restricting member that restricts the movement of the electric power supplying portion in the horizontal direction to only the longitudinal direction of the long groove by having a tip end portion fit into the long groove that serves as the movement guiding portion. If the movement guiding portion is formed by a mark, the electric power supplying portion may include a sensor that detects the mark that serves as the movement guiding portion, and controlling means for controlling the electric power supplying portion to move in the horizontal direction along the mark, based on the mark detection results by the sensor.

Also, in the charging apparatus described above, the electric power receiving portion of the vehicle is provided in a position offset to one end side in a vehicle longitudinal direction with respect to a center portion of the vehicle, and the state in which the electric power supplying portion is in a position corresponding to the electric power receiving portion of the vehicle, as the electric power supplying position, is a state in which electric power can be supplied to the vehicle. Also, the movement guiding portion is arranged along a section that extends from the second position to at least a position corresponding to the electric power receiving portion of the vehicle in one of the parking spaces when the vehicle is parked in the parking space of the parking lot while facing a first direction in which an end portion on the one end side in the vehicle longitudinal direction on which the electric power receiving portion is provided is closer to the second position than the end portion on the other end side. Also, with at least one of the parking spaces for a plurality of vehicles, the movement guiding portion extends to a position corresponding to the electric power receiving portion of the vehicle in one of the parking spaces when the vehicle is parked in the parking space while facing a second direction that is opposite the first direction.

As a result, with a parking space where the movement guiding portion extends, from among the plurality of parking spaces, electric power can be provided to a vehicle by the electric power supplying portion both when the vehicle is parked facing the first direction in the parking space and when the vehicle is parked facing the second direction in the parking space. Therefore, the degree of freedom with respect to the direction that the vehicle faces when the vehicle is parked in the parking lot and the secondary battery is charged while the vehicle is parked is increased.

Further, in the charging apparatus described above, the controlling means may position the electric power supplying portion in the second position before a vehicle to be supplied with electric power by the electric power supplying portion arrives, by moving the electric power supplying portion to the second position when the vehicle has finished being supplied with electric power by the electric power supplying portion.

As a result, the electric power supplying portion is withdrawn to the second position (that is a position outside a range that would interfere with a vehicle pulling into or out of the parking lot) at times other than when electric power is being supplied to the vehicle. This makes it possible to avoid the electric power supplying portion interfering with (i.e., getting in the way of) a vehicle pulling into or out of the parking lot.

Also, in the charging apparatus described above, an image of the license plate of the parked vehicle may be taken and the determination as to whether a vehicle parked in one of the parking spaces of the parking lot is an authorized vehicle that has been preregistered for the parking space in which it is parked may be made based on recognition results of the characters on the license plate, for example. Also, for example, in the charging apparatus described above, the determining means may include a function of performing wireless communication with the vehicle, and the determining means may determine whether the vehicle is the authorized vehicle of the parking space by comparing identification information of the vehicle received via wireless communication from the vehicle parked in the parking space of the parking lot with identification information of the authorized vehicle preregistered for the parking space. In this case, it is more difficult to fake than it is with a mode in which, for example, the characters on the license plate of the vehicle are recognized. As a result, the determination accuracy of whether the vehicle is an authorized vehicle is improved.

Also, in the charging apparatus described above, the detecting means may include a function of performing wireless communication with the vehicle, and the detecting means may detect the state of charge of the secondary battery of the vehicle by receiving via wireless communication information indicating the state of charge of the secondary battery of the vehicle from the vehicle parked in the parking space of the parking lot. Incidentally, instead of this, information such as the running distance of the vehicle after the last charge, for example, may be received from the vehicle via wireless communication, and the state of charge of the secondary battery of the vehicle may be detected by being calculated from the received information.

Also, in the charging apparatus described above, when there are a plurality of vehicles parked in the parking lot that are determined by the determining means to be authorized vehicles and in which the state of charge of the secondary battery detected by the detecting means is equal to or less than a predetermined value, the controlling means may control the electric power supplying portion to supply electric power to a plurality of vehicles to be supplied with electric power in order, according to an electric power supplying priority order for each authorized vehicle that has been preset based on at least one of an average parking lot leaving time of each authorized vehicle corresponding to a different parking spaces, among the parking spaces of the parking lot for a plurality of vehicles, an average running distance per charge of each authorized vehicle, and an average charging time per charge of each authorized vehicle.

As a result, even if there are a plurality of vehicles to be supplied with electric power by the electric power supplying portion in the parking lot, electric power can be supplied to the plurality of vehicles to be supplied with electric power in an appropriate order, according to the electric power supplying priority order that has been preset based on at least one of the average leaving time, the average running distance, or the average charging time of each authorized vehicle.

Also, in the charging apparatus described above, the controlling means may include a function of performing wireless communication with the vehicle. Also, when there are a plurality of vehicles parked in the parking lot that are determined by the determining means to be authorized vehicles and in which the state of charge of the secondary battery detected by the detecting means is equal to or less than a predetermined value, the controlling means may i) obtain at least one of the state of charge of the secondary battery, a planned parking lot leaving time or an average parking lot leaving time, a running distance after the last charging or an average running distance per charge, and an average charging time per charge, ii) determine an order by which to supply electric power to a plurality of vehicles to be supplied with electric power based on the obtained information, and iii) control the electric power supplying portion to supply electric power to the plurality of vehicles to be supplied with electric power in the determined order.

As a result, electric power can be supplied to a plurality of vehicles to be supplied with electric power, in an appropriate order. The controlling means determines the order in which to supply electric power to the plurality of vehicles, so even though the load on the controlling means is greater, it is possible to supply electric power to a plurality of vehicles to be supplied with electric power in a more appropriate order according to the current state and plans of each vehicle, when determining the order in which to supply electric power to a plurality of vehicles to be supplied with electric power based on parameters (information) that may fluctuate each time charging is performed, such as the state of charge of the secondary battery and the planned parking lot leaving time in particular.

Also, the charging apparatus described above may also include a plurality of notifying means, each of which is arranged at a residence of each owner of the authorized vehicle in each parking space of the parking lot and is connected via a communication wire to the controlling means and is capable of giving notice that charging is complete. Also, when electric power has finished being supplied to the vehicle by the electric power supplying portion, the controlling means may control the notifying means that is arranged at the residence of the owner of the vehicle for which electric power has finished being supplied to give notice that charging is complete. As a result, the owner of each authorized vehicle is able to know whether his or her vehicle has finished charging without having to go out to the parking lot.

Also, the charging apparatus described above may also include electric power generating means for converting sunlight into electric power, and electric power storing means for storing electric power that has been generated by the electric power generating means. Further, the electric power supplying portion may be connected to the electric power storing means, and supply the electric power generated by the electric power generating means and stored in the electric power storing means to the vehicle. As a result, some or all of the electric power supplied to the vehicle parked in the parking lot can be covered by solar power, thus making is possible to suppress an increase in the amount of CO₂ discharged when supplying electric power to a vehicle parked in the parking lot (i.e., when charging the secondary battery of a vehicle parked in the parking lot).

The charging apparatus of the invention described above thus makes it possible to charge a parked vehicle regardless of which space in a parking lot that is provided with parking spaces for a plurality of vehicles the vehicle is parked in, with a simple structure.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a block diagram schematically showing a vehicle charging apparatus and peripheral apparatuses according to one example embodiment of the invention;

FIG. 2 is a perspective view of a parking lot provided with the vehicle charging apparatus according to the example embodiment of the invention;

FIG. 3 is a sectional view of the general structure of an electric power supplying portion according to the example embodiment of the invention;

FIG. 4A and FIG. 4B are side view of one example of a movable range of the electric power supplying portion in each parking space according to the example embodiment of the invention;

FIG. 5A and FIG. 5B are a flowchart illustrating a charging necessary/unnecessary determining routine according to the example embodiment of the invention; and

FIG. 6A and FIG. 6B are a flowchart illustrating a vehicle charging routine according to the example embodiment of the invention.

### DETAILED DESCRIPTION OF EMBODIMENTS

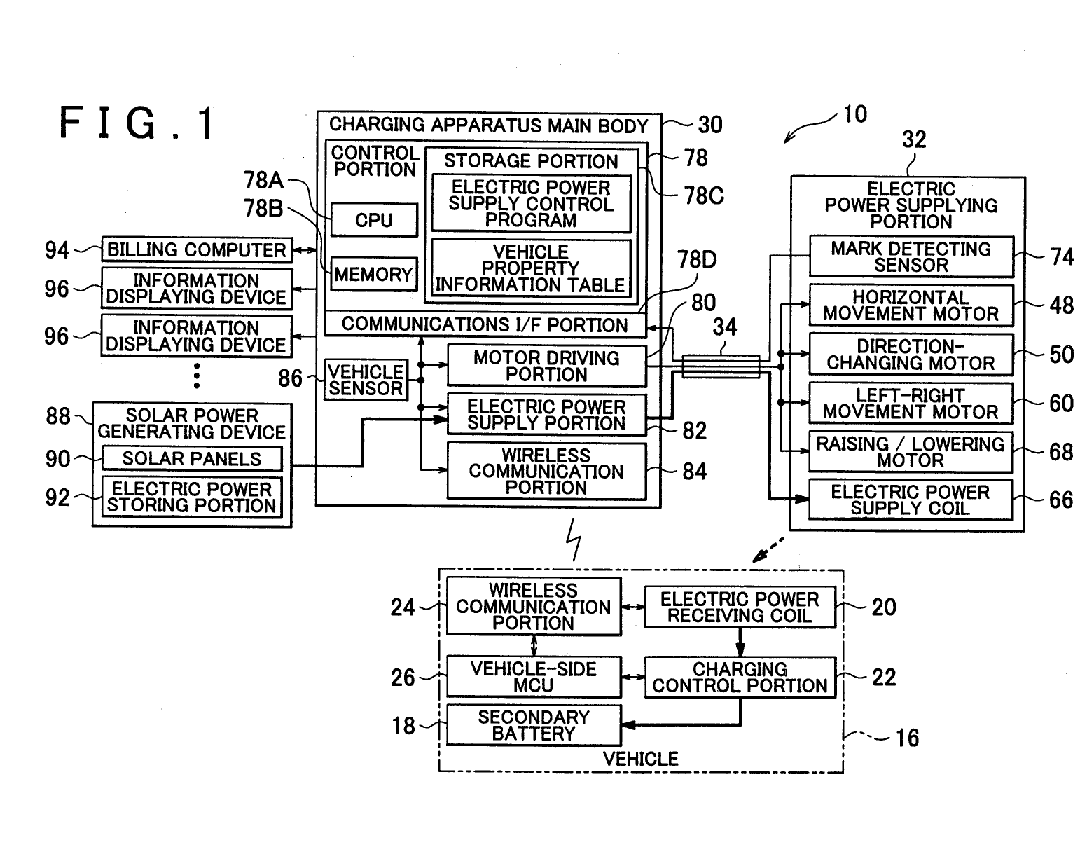

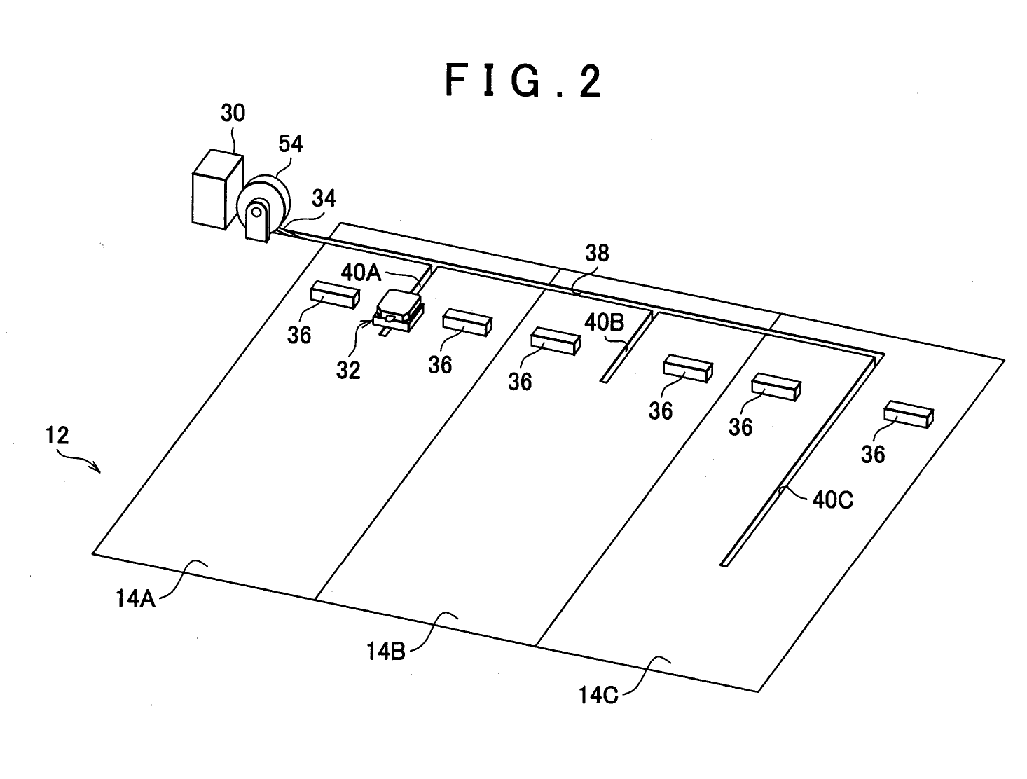

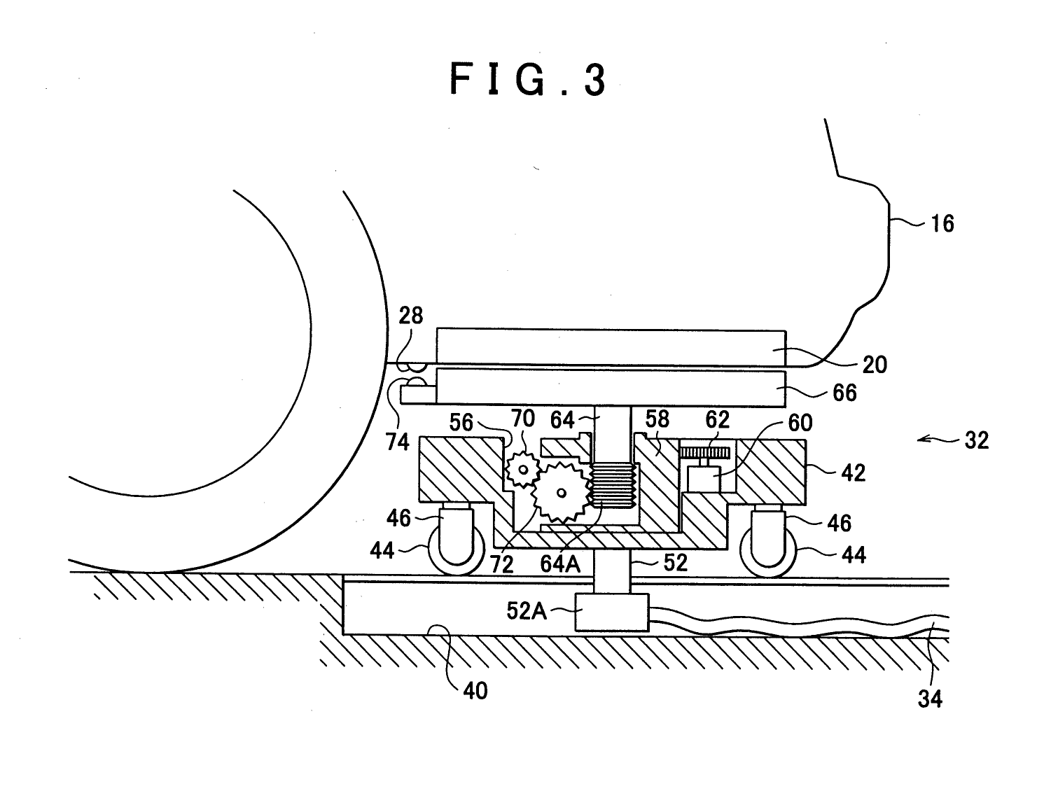

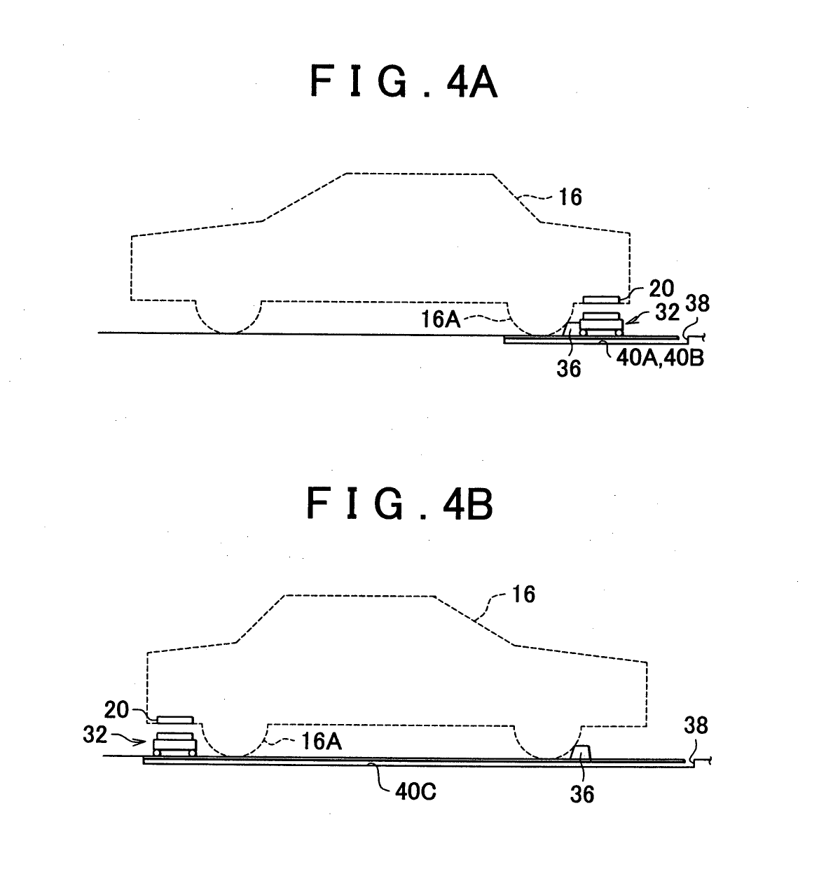

Hereinafter, one example embodiment of the invention will be described in detail with reference to the accompanying drawings. FIG. 1 is a view of a vehicle charging apparatus 10 according to this example embodiment. The vehicle charging apparatus 10 is arranged in a parking lot 12 that is provided with rectangular parking spaces 14 (i.e., 14A to 14C) for a plurality of vehicles as shown in FIG. 2, and serves to supply electric power for charging a secondary battery 18 mounted in a vehicle 16 parked in a given parking space 14 from among the parking spaces 14A to 14C, to the vehicle 16 (see FIGS. 3, 4A, and 4B). This vehicle charging apparatus 10 includes a charging apparatus main body 30, an electric power supplying portion 32, and a connecting cable 34 that connects the charging apparatus main body 30 with the electric power supplying portion 32. Incidentally, the number of parking spaces 14 in the parking lot 12 is not limited to three as shown in FIG. 2, but may also be two or four or more.

The secondary battery 18 is mounted in the vehicle 16 that is parked in the parking lot 12 (i.e., the vehicle 16 to be charged by the vehicle charging apparatus 10). An electric power receiving coil 20, a charging control portion 22, a wireless communication portion 24, and a vehicle-side MCU 26 are provided. The electric power receiving coil 20 is a coil for receiving a supply of electric power from the vehicle charging apparatus 10. As shown in FIGS. 3, 4A, and 4B, the electric power receiving coil 20 is provided in a position offset to one end side in the vehicle longitudinal direction from the center portion of the vehicle 16 (i.e., in a position farther to the rear, in the vehicle longitudinal direction, than the rear axle of the vehicle 16 in this example embodiment), on a bottom portion of the vehicle 16. Incidentally, the electric power receiving coil 20 corresponds to the “electric power receiving portion provided in a position offset to one end side in a vehicle longitudinal direction with respect to a center portion of the vehicle” of the invention. Also, the charging control portion 22 is provided between the secondary battery 18 and the electric power receiving coil 20. This charging control portion 22 performs tasks such as controlling the charging and discharging of (e.g., refreshing) the secondary battery 18 with electric power supplied from the vehicle charging apparatus 10 via the electric power receiving coil 20, and monitoring the current state of charge (SOC) of the secondary battery 18.

Further, the wireless communication portion 24 also performs wireless communication with the vehicle charging apparatus 10. Moreover, the vehicle-side MCU 26 is connected to the charging control portion 22 and the wireless communication portion 24, and transmits a vehicle ID permanently stored beforehand in internal memory, as well as the current SOC of the secondary battery 18 obtained by the charging control portion 22, to the vehicle charging apparatus 10 by the wireless communication portion 24 according to a request received from the vehicle charging apparatus 10 via the wireless communication portion 24. Also, the vehicle 16 is preferably a vehicle capable of running with an electric motor as the power source, such as an electric vehicle or a hybrid vehicle, for example.

Regarding the parking spaces 14A to 14C in the parking lot 12, the front side in FIG. 2 in the longitudinal direction of the parking spaces 14 is the side through which the vehicle 16 passes when the vehicle 16 pulls into or out of the parking space 14. A pair of car stops 36 is arranged at the back side of each of parking spaces 14A to 14C in FIG. 2. Also, in the parking spaces 14A to 14C, a transverse groove 38 is provided in the width direction of the parking spaces 14, so as to straddle the parking spaces 14A to 14C, further in back of the car stops 36 in FIG. 2. Incidentally, in this example embodiment, the “second position” refers to a space, in the parking space, that is opposite a space where the vehicle can park and that is separated from the space where the vehicle can park by the car stops.

Also, longitudinal grooves 40A to 40C are provided in the longitudinal direction of the parking spaces 14, in each of the parking spaces 14A to 14C. One end portion of each of these longitudinal grooves 40A to 40C is connected to the transverse groove 38. In this example embodiment, the length of the longitudinal grooves 40A and 40B is different than the length of the longitudinal groove 40C. The other end portion of each of the longitudinal grooves 40A and 40B is positioned near rear wheels 16A of the vehicle 16 that contact the car stops 36 when the vehicle 16 is parked backed into the corresponding parking space 14, and the longitudinal grooves 40A and 40B extend from this position to the transverse groove 38, as shown in FIG. 4A. On the other hand, the longitudinal groove 40C is provided extending farther back in the vehicle longitudinal direction than the rear wheels 16A of the vehicle 16 that do not contact the car stops 36 when the vehicle 16 is parked front end into the corresponding parking space 14, as shown in FIG. 4B. Incidentally, the transverse groove 38 and the longitudinal grooves 40A to 40C correspond to the movement guiding portion of the invention.

In this example embodiment, the electric power supplying portion 32 is able to move horizontally along the transverse groove 38 and the longitudinal grooves 40. Therefore, with the parking spaces 14A and 14B, the electric power supplying portion 32 is able to move to an electric power suppliable position (an example of the “first position” of the invention) directly below the electric power receiving coil 20 provided in the vehicle 16 only when the vehicle 16 is parked backed into the corresponding parking space 14, as shown in FIG. 4A. In contrast, with the parking space 14C, the electric power supplying portion 32 is able to move to an electric power suppliable position directly below the electric power receiving coil 20 provided in the vehicle 16, as shown in FIG. 4B, not only when the vehicle 16 is parked backed into the corresponding parking 14, but also when the vehicle 16 is parked front end into the corresponding parking space 14.

As shown in FIG. 3, the electric power supplying portion 32 has a base 42 that serves as the base portion of the invention. Four (only two are shown in FIG. 3) support members 46 that rotatably support wheels 44 are attached to the base 42. A horizontal movement motor 48 and a direction-changing motor 50 (see FIG. 1) are attached to the base 42. The driving force of the horizontal movement motor 48 is transmitted via a driving force transmitting mechanism, not shown, to rotatably drive two of the four wheels 44. The driving force of the direction-changing motor 50 is transmitted via a driving force transmitting mechanism, not shown, to pivot the support members 46 that support the remaining two wheels 44 about a perpendicular axis with respect to the base 42. Accordingly, the base 42 (i.e., the electric power supplying portion 32) is made to move horizontally by the driving force of the horizontal movement motor 48, and the direction of movement within a horizontal plane is changed by the driving force of the direction-changing motor 50.

A cylindrical guide member 52 is provided upright on a bottom portion of the base 42. A tip end portion of this guide member 52 fits into the transverse groove 38 or the longitudinal grooves 40, and is provided with a large-diameter portion 52A to prevent it from coming out of the transverse groove 38 or the longitudinal groove 40. Accordingly, horizontal movement of the base 42 (i.e., the electric power supplying portion 32) is restricted to the direction and range of the transverse groove 38 or the longitudinal groove 40.

Also, one end of the connecting cable 34 is connected to the large-diameter portion 52A, and a middle portion of the connecting cable 34 is housed in the transverse groove 38 or the longitudinal groove 40. As shown in FIG. 2, a winding drum 54 (and the charging apparatus main body 30) is provided near one end portion of the transverse groove 38. The other end portion of the connecting cable 34 is wound up on the winding drum 54. The winding drum 54 urges the connecting cable 34 in the winding direction. When the base 42 (i.e., the electric power supplying portion 32) moves horizontally away from the winding drum 54, the connecting cable 34 is pulled off of the winding drum 54 against the winding force of the winding drum 54. On the other hand, when the base 42 (i.e., the electric power supplying portion 32) moves horizontally toward the winding drum 54, the excess connecting cable 34 is wound up on the winding drum 54 by the winding force of the winding drum 54.

Also, a groove portion 56 that is open upward is formed in the center portion of the base 42, and a support member 58 is housed in this groove portion 56. The direction of movement of the support member 58 inside the groove portion 56 is restricted only to the direction perpendicular to the surface of the paper on which FIG. 3 is drawn (i.e., the left-right direction of the vehicle 16 when the electric power supplying portion 32 is in an electric power suppliable position), by a guide member, not shown, provided in the groove portion 56. Also, a left-right movement motor 60 (see also FIG. 1) is provided in the groove portion 56. A pinion gear 62 that is in mesh with a rack, not shown, provided on a side surface of the support member 58 is attached to a rotating shaft of the left-right movement motor 60. As a result, when the rotating shaft of the left-right movement motor 60 is rotatably driven, the support member 58 slides inside the groove portion 56 in the direction perpendicular to the surface of the paper on which FIG. 3 is drawn (i.e., in the left-right direction of the vehicle 16 when the electric power supplying portion 32 is in an electric power suppliable position).

Also, the support member 58 supports a mid portion of a raising/lowering rod 64 provided in the vertical direction. A male thread 64A is formed on a base portion of the raising/lowering rod 64. An electric power supply coil 66 for supplying electric power to the vehicle 16 via the electric power receiving coil 20 provided in the vehicle 16 is attached to a tip end portion of the raising/lowering rod 64. A raising/lowering motor 68 (see FIG. 1) is attached to the support member 58. A gear 70 is attached to a rotating shaft of the raising/lowering motor 68. This gear 70 is in mesh with the male thread 64A via a gear 72. Therefore, when the rotating shaft of the raising/lowering motor 68 is rotatably driven, the raising/lowering rod 64 and the electric power supply coil 66 move up and down in a direction perpendicular to the support member 58.

Also, a mark 28 is provided near the position where the electric power receiving coil 20 is arranged on the bottom portion of the vehicle 16, and a mark detecting sensor 74 is provided on a side portion of the electric power supply coil 66 of the electric power supplying portion 32, in a position so as to be opposite the mark 28 when the electric power supplying portion 32 is in the electric power suppliable position. A sensor provided with a light emitting portion and a light receiving portion, and that is configured to optically detect the mark 28, may be used as the mark detecting sensor 74. In this case, the mark 28 may be formed by a highly reflective member.

Incidentally, the electric power supplying portion 32 corresponds to the electric power supplying portion of the invention. The base 42 corresponds to the electric power supplying means of the invention. The horizontal movement motor 48 and the direction-changing motor 50 correspond to the horizontal moving means of the invention, and the raising/lowering motor 68 corresponds to the raising/lowering means of the invention.

Meanwhile, the charging apparatus main body 30 includes a control portion 78. This control portion 78 is formed by a microcomputer, and includes a CPU 78A, memory 78B, a nonvolatile storage portion 78C formed by a HDD (Hard Disk Drive) or flash memory, and a communications I/F (interface) portion 78D. Electric power supply control programs that include a charging necessary/unnecessary determining program for executing a charging necessary/unnecessary determining routine that will be described later, and a vehicle charging program for executing a vehicle charging routine that will also be described later, are installed in the storage portion 78C in advance. A vehicle property information table is also stored in the storage portion 78C. The control portion 78 functions as the determining means of the invention, the detecting means of the invention, and the controlling means of the invention, by the CPU 78a executing the charging necessary/unnecessary determining program and the vehicle charging program described above.

Also, various property information (such as the vehicle ID, the average leaving time (that the vehicle 16 leaves the parking space), the average running distance on one charge, and the average charging time for one charge) related to the authorized vehicle 16 that is pre-assigned to each parking space 14A to 14C in the parking lot 12 is stored beforehand in the vehicle property information table. Incidentally, the average leaving time can be detected by a vehicle sensor 86, the charging time can be detected by the control portion 78, and the running distance on one charge can be obtained from the vehicle 16 by the control portion 78. Therefore, of the property information described above, the average leaving time, the average running distance on one charge, and the average charging time for one charge and the like may be updated as appropriate by the control portion 78.

Also, various portions and sensors and the like are connected to the charging apparatus main body 30. These include a motor driving portion 80 that is connected via the connecting cable 34 to the various motors provided in the electric power supplying portion 32 and drives these various motors, an electric power supply portion 82 that is connected via the connecting cable 34 to the electric power supply coil 66 of the electric power supplying portion 32 and generates electric power to be supplied to the vehicle 16 that is to be charged, a wireless communication portion 84 that is able to wirelessly communicate with the wireless communication portion 24 provided in the vehicle 16, and the vehicle sensor 86 that is provided for each parking space 14A to 14C in the parking lot 12 and detects whether the vehicle 16 is parked in the individual parking spaces 14A to 14C. These are all connected to the communications I/F portion 78D of the control portion 78. Incidentally, the mark detecting sensor 74 is also connected via the connecting cable 34 to the communications I/F portion 78D.

The electric power supply portion 82 is connected to a system power supply (such as a commercial power supply provided by an electric power company; not shown), and is also connected to a solar power generating device 88 that includes solar panels 90 that convert sunlight into electric power, and an electric power storing portion 92 that stores the electric power generated by the solar panels 90. The solar power generating device 88 is configured to preferentially supply electric power generated and stored by the solar power generating device 88 to the vehicle 16 to be charged, and cover any insufficiency with electric power supplied from the system power supply. Incidentally, when the residence of the owner of each authorized vehicle 16 parked in parking spaces 14A to 14C of the parking lot 12 is an apartment building or the like, the solar panels 90 of the solar power generating device 88 may be arranged on the roof of the apartment building, for example. Also, the solar panels 90 correspond to the electric power generating means of the invention, and the electric power storing portion 92 corresponds to the power storing means of the invention.

Also, a billing computer 94 is connected to the charging apparatus main body 30. This billing computer 94 is a computer for calculating, for each authorized vehicle 16, the price of the service provided by the vehicle charging apparatus 10 to the owner of each authorized vehicle 16 parked in the parking lot 12 (i.e., of the charging service that provides electric power for charging the secondary battery 18 of each authorized vehicle 16 to each authorized vehicle 16). The charging apparatus main body 30 notifies the billing computer 94, for each authorized vehicle 16, of the amount of electric power supplied to the vehicle 16, and bills based on the notified amount of electric power. Incidentally, when the residence of the owner of each vehicle 16 is a rented accommodation, the billing computer 94 may also add the price of the charging service to the rent of the rented accommodation, and bill to charge the owner of each authorized vehicle 16.

Also, a plurality of information displaying devices 96 are also connected to the charging apparatus main body 30. Each information displaying device 96 includes a display formed of an LCD or the like that is able to display the appropriate information, and an operating portion provided with a plurality of individual keys. Each of these information displaying devices 96 is installed at the residence of the owner of each authorized vehicle 16 parked in the parking lot 12. The charging apparatus main body 30 displays messages and the like that notify the owner of the authorized vehicle 16 of various information (that will be described in detail later), on the display of the information displaying device 96. The owner of the authorized vehicle 16 parked in the parking lot 12 is also able to input information, such as the planned leaving time of the vehicle 16, by operating the operating portion of the information displaying device 96. The information such as the planned leaving time of the vehicle 16 that has been input by the owner of the authorized vehicle 16 operating the operating portion of the information displaying device 96 is stored in the vehicle property information table described above. Incidentally, the information displaying device 96 corresponds to the notifying means of the invention.

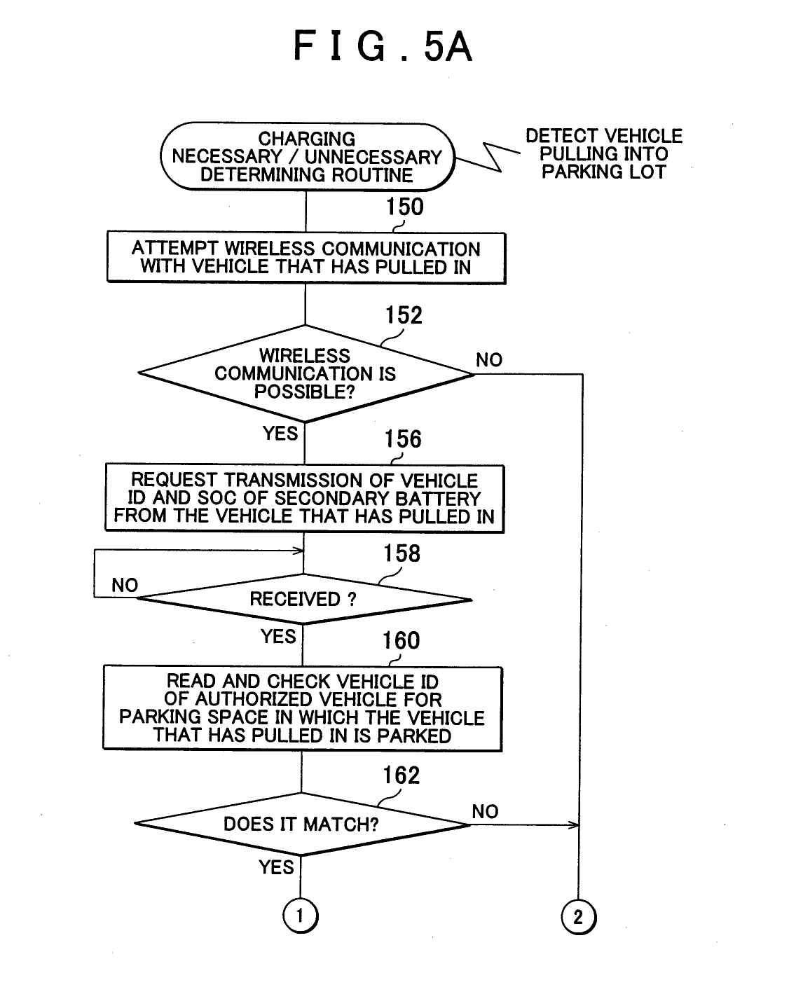

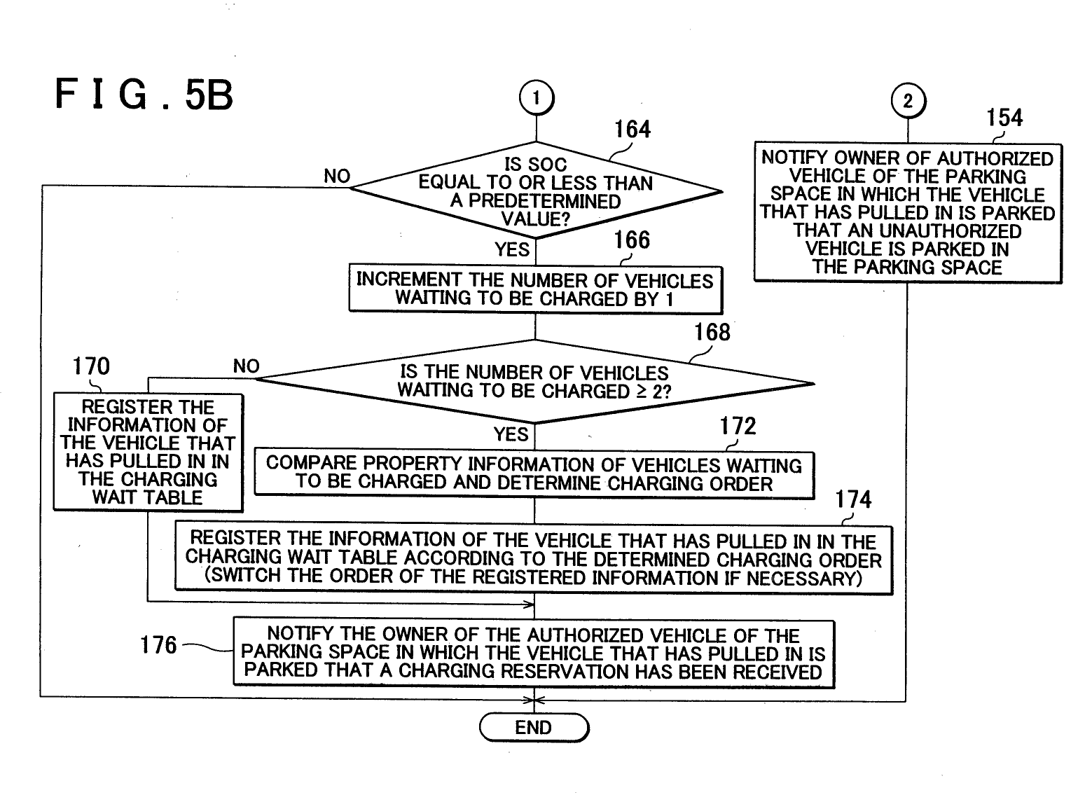

Next, the operation of this example embodiment will be described. In this example embodiment, each time the vehicle 16 pulls into (i.e., enters or parks in) one of the parking spaces 14A to 14C in the parking lot 12, this arrival of vehicle 16 is detected by the vehicle sensor 86. Then the charging necessary/unnecessary determining routine shown in FIG. 5A and FIG. 5B is performed by the control portion 78 of the charging apparatus main body 30 by executing the charging necessary/unnecessary determining program included in the power supply control programs by the CPU 78A in response to the arrival of the vehicle 16 being detected.

With this charging necessary/unnecessary determining routine, first in step 150 in FIG. 5A and FIG. 5B, wireless communication with the vehicle 16 that has pulled in the parking lot 12 this time is attempted by the wireless communication portion 84 transmitting via wireless communication predetermined information to the vehicle 16 that has arrived in the parking lot 12 this time. Next in step 152, it is determined whether wireless communication with the parked vehicle 16 that has pulled in this time is possible based on whether the wireless communication portion 84 has received a response from the vehicle 16 that has pulled in this time to the information transmitted in step 150. If the wireless communication portion 84 has not received a response from the vehicle 16 that has pulled in this time, it is determined that the vehicle 16 that has pulled in this time to the parking lot 12 is not an authorized vehicle 16 permitted to park in the parking lot 12, so the determination in step 152 is no. In this case, the process proceeds on to step 154 in which the owner of the vehicle 16 authorized for the parking space 14 in which the vehicle 16 that has pulled in this time is parked is notified via the information displaying device 96 that an unauthorized vehicle 16 is parked in his or her space, and then the charging necessary/unnecessary determining routine ends.

Also, if the wireless communication portion 84 receives a response from the vehicle 16 that has pulled in this time, the determination in step 152 is yes and the process proceeds on to step 156 in which the wireless communication portion 84 transmits, via wireless communication, information requesting transmission of the vehicle ID and SOC of the secondary battery 18 to the vehicle 16 that has pulled in this time. Then in step 158, it is determined whether any information has been received from the vehicle 16 that has pulled in this time. Step 158 is repeated until the determination is yes. When the wireless communication portion 84 receives some information from the vehicle 16 that has pulled in this time, the determination in step 158 is yes and the process proceeds on to step 160. In step 160, the vehicle ID of the vehicle 16 authorized for the parking space 14 in which the vehicle 16 that has pulled in this time is parked is read from the vehicle property information table stored in the storage portion 78C, and the vehicle ID in the received information is checked against the vehicle ID of the authorized vehicle 16 that has been read. Next, in step 162, it is determined whether the vehicle IDs match. Incidentally, steps 156 to 162 correspond to processes by the determining means of the invention, and steps 156 and 158 correspond to processes by the detecting means of the invention.

If the determination in step 162 is no, then it can be determined that the vehicle 16 that has pulled in this time is not the authorized vehicle 16 of the parking space 14 in which it is parked, even though the vehicle 16 that has pulled in this time has a wireless communication portion 24 or the like. Therefore, the process proceeds on to step 154 in which, as described above, the owner of the vehicle 16 authorized for the parking space 14 in which the vehicle 16 that has pulled in this time is parked is notified via the information displaying device 96 that an unauthorized vehicle 16 is parked in his or her space, and then the charging necessary/unnecessary determining routine ends.

If, on the other hand, the determination in step 162 is yes, then it can be determined that the vehicle 16 that has pulled in this time is the vehicle 16 that is authorized for the parking space 14 in which it is parked, so the process proceeds on to step 164 in which it is determined whether the SOC of the secondary battery 18 of the vehicle 16 that has pulled in this time is equal to or less than a predetermined value based on information indicating the SOC of the secondary battery 18 that is included in the information received from the vehicle 16 that has pulled in this time. If the determination in step 164 is no, it can be determined that the secondary battery 18 of the authorized vehicle 16 that has pulled in this time does not need to be charged, so the charging necessary/unnecessary determining routine ends. Incidentally, if the determination in step 164 is no, the owner of the authorized vehicle 16 that has pulled in this time is notified via the information displaying device 96 that the SOC is sufficient so the secondary battery 18 will not be charged.

Also, if the determination in step 164 is yes, it can be determined that the secondary battery 18 of the authorized vehicle 16 that has pulled in this time needs charging, so the process proceeds on to step 166 in which a value for the number of vehicles waiting to be charged (the initial value is 0) stored in the memory 78B is incremented by 1. Next in step 168, it is determined whether the number of vehicles waiting to be charged has become equal to or greater than two (i.e., whether there are already other authorized vehicles 16 that are waiting to be charged) as a result of updating the value for the number of vehicles waiting to be charged in step 166.

If the determination in step 168 is no (i.e., if there are no other authorized vehicles 16 waiting to be charged), the process proceeds on to step 170 in which the information of the authorized vehicle 16 that has pulled in this time (such as the vehicle ID, the information identifying the parking space 14, and the SOC of the secondary battery 18) is registered in a charging wait list (hereinafter referred to as a “charging wait table”), after which the process proceeds on to step 176. In step 176, the owner of the authorized vehicle 16 that has pulled in this time is notified via the information displaying device 96 that a charging reservation has been received, and the charging necessary/unnecessary determining routine ends. Incidentally, in step 176 the estimated time of charging completion or the like may also be calculated and the owner notified.

Also, if the determination in step 168 is yes (i.e., if there are other authorized vehicles 16 waiting to be charged), the process proceeds on to step 172 in which the property information of the other authorized vehicles 16 waiting to be charged is read from the vehicle property information table stored in the storage portion 78C, this read property information is then compared with the property information of the authorized vehicle 16 that has pulled in this time read earlier in the step 160, and the charging order for a plurality of authorized vehicles 16 waiting to be charged is determined based on the comparison results.

There are many conceivable ways to determine the charging order for a plurality of vehicles 16 waiting to be charged. For example, one way to determine the charging order is to compare the average leaving time included in the property information among vehicles 16 that are waiting to be charged (for vehicles 16 in which the estimated leaving time has been input via the operating portion of the information displaying device 96 by the owner of the vehicle 16, the estimated leaving time that has been input is used instead of the average leaving time), and charge the vehicles 16 in order starting with the earliest leaving time. Another way to determine the charging order is to compare the average running distance per charge that is included in the property information among the vehicles 16 waiting to be charged, and charge the vehicles 16 in descending order (or ascending order) of the average running distance per charge. Yet another way to determine the charging order is to compare the average charging times per charge included in the property information among the vehicle 16 waiting to be charged, and charge the vehicles 16 in descending order (or ascending order) of the average charging time per charge. Furthermore, the charging order may be determined based on a combination of the information described above. For example, the charging order may be determined based on the leaving time if the difference between leaving times is equal to or greater than a predetermined period of time, or the charging order may be based on the average running distance per charge or the average charging time per charge if the difference in leaving times is less than the predetermined period of time.

Also, a charging priority order for authorized vehicles may be preset by applying any of the methods described above, and if there is a plurality of vehicles 16 waiting to be charged, the charging order of the vehicles 16 may be determined according to the preset charging priority order. Also, the method for determining the charging order is not limited to those described above. That is, another way to determine the charging order is to compare the SOC of the secondary battery 18 obtained from the vehicles 16 waiting to be charged among the vehicles 16, and charge the vehicles 16 in an ascending order (or descending order) of the SOC of the secondary battery 18. Still another way to determine the charging order is to simply charge the vehicles 16 in the order in which they arrived at the parking lot 12. Another way to determine the charging order is to give priority to charging the vehicle 16 of an owner who has signed a contract in advance that gives priority to charging his or her vehicle 16.

Once the charging order for a plurality of vehicles 16 waiting to be charge is determined in step 172, the process proceeds on to step 174. In step 174, the information (such as the vehicle ID, information identifying the parking space 14, and the SOC of the secondary battery 18) of the authorized vehicle 16 that has pulled in this time is registered in the charging wait table, and if the charging order determined in step 172 is an order that calls for charging the authorized vehicle 16 that has pulled in this time before charging another authorized vehicle 16 that is already parked and waiting to be charged, the order of the information of the vehicles 16 registered in the charging wait table is switched. Then in step 176, the owner of the authorized vehicle 16 that has pulled in this time is notified via the information displaying device 96 that a charging reservation has been received, and the charging necessary/unnecessary determining routine ends. Incidentally, in this case as well, the estimated time of charging completion or the like may also be calculated and the owner notified.

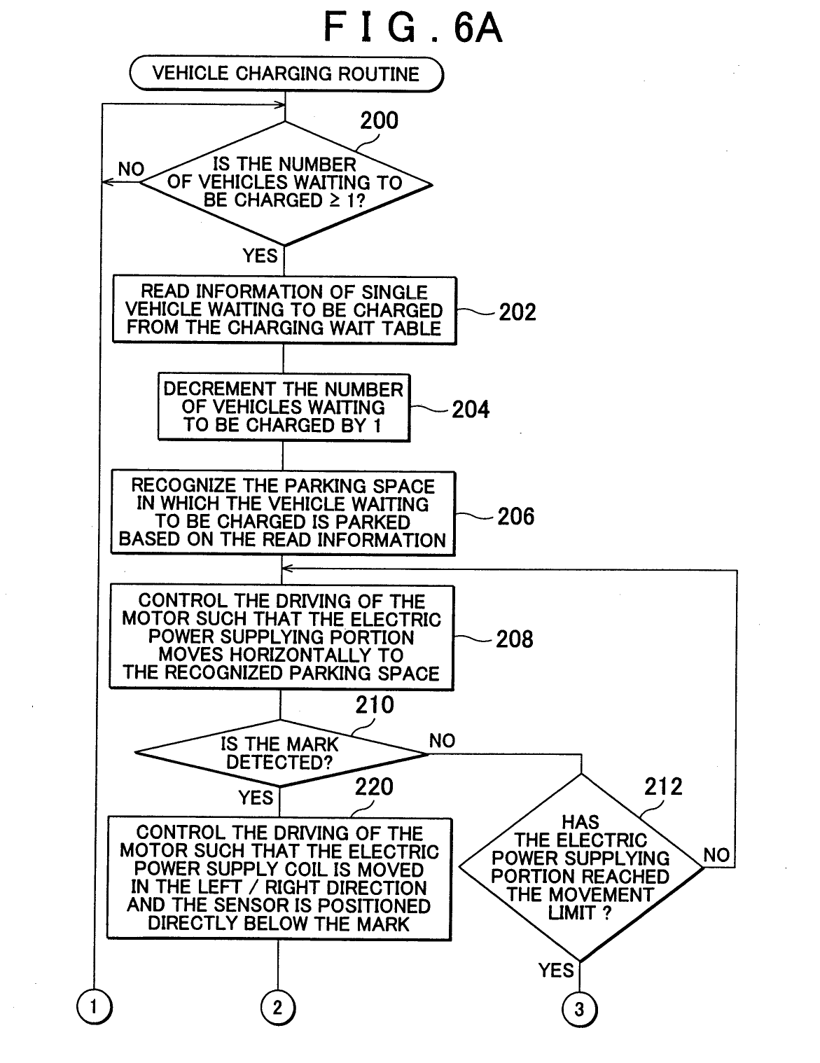

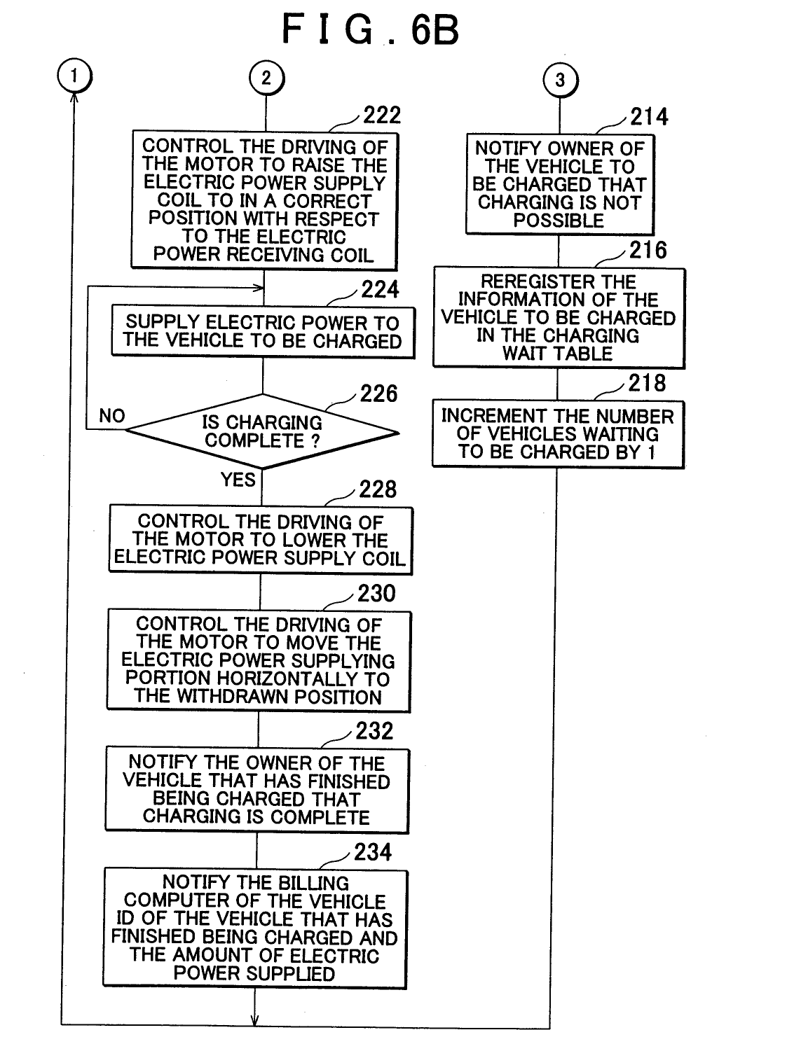

Also, the control portion 78 of the charging apparatus main body 30 always executes the vehicle charging routine shown in FIG. 6A and FIG. 6B by having the CPU 78A execute the vehicle charging program included in the electric power supply control programs non-simultaneously with the vehicle 16 entering the parking lot 12.

With this vehicle charging routine, first in step 200, it is determined whether a value for the number of vehicles waiting to be charged that is stored in the memory 78B is equal to or greater than 1. This step 200 is repeated until the determination is yes. When an authorized vehicle 16 in which the SOC of the secondary battery 18 is equal to or less than a predetermined value enters one of the parking spaces 14A to 14C in the parking lot 12, the value of the number of vehicles waiting to be charged is incremented by 1 according to the charging necessary/unnecessary determining routine (FIG. 5A and FIG. 5B) described above. As a result, the determination in step 200 is yes and the process proceeds on to step 202.

In step 202, the information (such as the vehicle ID, the information identifying the parking space 14, and the SOC of the secondary battery 18) of a single vehicle 16 (the vehicle 16 at the top of the charging order) that is waiting to be charged and is registered at the top of the charging wait table, is read from the charging wait table. Also, next in step 204, the value for the number of vehicles waiting to be charged that is stored in the memory 78B is decremented by 1. In step 206, the parking space 14 in which the vehicle 16 to be charged that corresponds to the read information is recognized based on the information read from the charging wait table in step 202.

In step 208, the motor driving portion 80 controls the driving of the horizontal movement motor 48 and the direction-changing motor 50 to first move the electric power supplying portion 32 horizontally along the transverse groove 38 toward the connecting portion of the transverse groove 38 and a specific longitudinal groove 40 provided in the parking space 14 recognized in step 206, and then change the direction in which the electric power supplying portion 32 moves at the connecting portion 90° and move it along the specific longitudinal groove 40. Also, when the electric power supplying portion 32 approaches the electric power suppliable position (the position shown in FIG. 4A) in the parking space 14 in which the vehicle 16 to be charged is parked by moving horizontally the electric power supplying portion 32, the process proceeds on to step 210 in which it is determined whether the mark 28 provided on the vehicle 16 to be charged has been detected by the mark detecting sensor 74 of the electric power supplying portion 32. If the determination in step 210 is no, the process proceeds on to step 212 in which it is determined whether the electric power supplying portion 32 has reached a movement limit position in the specific longitudinal groove 40 (i.e., a position in the specific longitudinal groove 40 that corresponds to the end portion on the opposite side of the connecting portion with the transverse groove 38). If this determination is also no, then the process returns to step 208 and the electric power supplying portion 32 continues to be moved horizontally until the determination in step 210 or step 212 is yes.

Here, if the electric power supplying portion 32 reaches the movement limit position in the specific longitudinal groove 40 without the mark 28 provided on the vehicle 16 to be charged being detected by the mark detecting sensor 74 of the electric power supplying portion 32, the position of the vehicle 16 to be charged in the parking space 14 may be greatly off from the normal parking position, or the vehicle 16 to be charged may be parked front end in in a parking space 14A or 14B in which electric power can only be supplied to the vehicle 16 when the vehicle 16 is parked backed into the parking space 14A or 14B, for example.

Therefore, if the determination in step 212 is yes, the process proceeds on to step 214 in which the owner of the vehicle 16 to be charged is notified via the information displaying device 96 that the vehicle 16 is unable to be charged. Also, in step 216, the information of the vehicle 16 to be charged that had been read from the charging wait table back in step 202 is reregistered in the charging wait table. Then in step 218, the value for the number of vehicles waiting to be charged that is stored in the memory 78B is incremented by 1 and the process returns to step 200. In this case, electric power is supplied to the vehicle 16 to be charged after the owner of the vehicle 16 to be charged has been notified and changes the direction in which the vehicle 16 to be charged is facing or corrects the parking position of the vehicle 16 to be charged or the like.

On the other hand, if the vehicle 16 to be charged is parked in the correct position in the parking space 14 (and further, in the case of the parking space 14A or 14B, the vehicle 16 to be charged is parked facing the correct direction), the determination in step 210 will become yes by the mark 28 provided on the vehicle 16 to be charged being detected by the mark detecting sensor 74 of the electric power supplying portion 32 before the electric power supplying portion 32 reaches the movement limit position in the specific longitudinal groove 40. When the determination in step 210 becomes yes, the electric power supplying portion 32 stops being moved horizontally and the process proceeds on to step 220. In step 220, the left-right movement motor 60 is driven by the motor driving portion 80 to move the support member 58 that includes the electric power supply coil 66 in the left/right direction of the vehicle 16 to be charged, while monitoring the change in the amount of light received by the mark detecting sensor 74, in search of the position where the amount of light received by the mark detecting sensor 74 is greatest, i.e., the position in which the mark detecting sensor 74 is directly below the mark 28 such that the electric power supply coil 66 faces the electric power receiving coil 20 of the vehicle 16, and the support member 58 that includes the electric power supply coil 66 is moved to this position.

Next in step 222, the motor driving portion 80 controls the driving of the raising/lowering motor 68 such that the electric power supply coil 66 is raised to the correct position (the position shown in FIG. 3) a fixed distance from the electric power receiving coil 20. Incidentally, this fixed distance between the electric power supply coil 66 and the electric power receiving coil 20 can be realized by first raising the electric power supply coil 66 to a position where it contacts the electric power receiving coil 20 and then lowering it a specific amount, for example. Next in step 224, electric power supply portion 82 supplies electric power to electric power supply coil 66. Accordingly, the secondary battery 18 of the vehicle 16 to be charged is charged by supplying electric power that has been supplied to the electric power supply coil 66 to the electric power receiving coil 20 of the vehicle 16 to be charged from the electric power supply coil 66.

Next in step 226, it is determined whether charging of the secondary battery 18 is complete. Incidentally, an inquiry may be made to the vehicle 16 to be charged regarding the current SOC of the secondary battery 18, and the determination may be made based on the current SOC of the secondary battery 18 received from the vehicle 16 to be charged, or the charging time may be calculated based on the SOC of the secondary battery 18 included in the information read from the charging wait table back in step 202, and it may be determined whether the calculated charging time has passed. If the determination in step 226 is no, the process returns to step 224 and steps 224 and 226 are repeated until the determination in step 226 is yes.

When the charging of the secondary battery 18 of the vehicle 16 to be charged is complete, the determination in step 226 is yes and the process proceeds on to step 228 where the motor driving portion 80 controls the driving of the raising/lowering motor 68 such that the electric power supply coil 66 of the electric power supplying portion 32 is lowered to a lower limit position. Next in step 230, the motor driving portion 80 controls the driving of the horizontal movement motor 48 and the driving of the direction-changing motor 50 such that the electric power supplying portion 32 moves horizontally toward a withdrawn position (one example of the second position of the invention). Incidentally, this withdrawn position may be any position as long as it is along the transverse groove 38. For example, the electric power supplying portion 32 may be withdrawn to a position where the transverse groove 38 is provided in the parking space 14 in which the vehicle 16 that has finished being charged is parked, or if the value for the number of vehicles waiting to be charged is 0, the electric power supplying portion 32 may be withdrawn to a position near the winding drum 54.

Next in step 232, the owner of the vehicle 16 that has finished being charged is notified via the information displaying device 96 that charging of the secondary battery 18 of the vehicle 16 is complete. Also, in step 234, the billing computer 94 is also notified of the vehicle ID of the vehicle 16 that has finished being charged and the amount of electric power supplied to the vehicle 16 during the period during which the secondary battery 18 is charged. As a result, regardless of which of the parking spaces 14A to 14C of the parking lot 12 that the vehicle 16 is parked in, as long as the vehicle 16 that is parked is an authorized vehicle 16 and the SOC of the secondary battery 18 is equal to or less than a predetermined value, step 202 and the subsequent steps will be performed in order with respect to the vehicle 16, and the secondary battery 18 will be charged. Incidentally, the vehicle charging routine (FIG. 6A and FIG. 6B), as well as steps 164 to 174 of the charging necessary/unnecessary determining routine (FIG. 5A and FIG. 5B) described above, correspond to a routine and steps, executing by the controlling means of the invention.

Incidentally, in the description above, of the parking spaces 14A to 14C provided in the parking lot 12, the parking spaces 14A and 14B are such that electric power can only be supplied to a vehicle 16 that is parked backed in, while the parking space 14C is such that electric power can also be supplied to a vehicle 16 that is parked front end in. However, the invention is not limited to this. For example, all of the parking spaces provided in the parking lot 12 may be such that electric power can also be supplied to a vehicle 16 that is parked front end in, or all of the parking spaces provided in the parking lot 12 may be such that electric power can only be provided to a vehicle 16 that is parked backed in.

Further, in the description above, the transverse groove 38 and the longitudinal grooves 40A to 40C are provided as examples of the movement guiding portion of the invention. Alternatively, however, the movement guiding portions may be a mark or the like provided along a path that allows the electric power supplying portion 32 to move. In this case, a sensor that detects the mark may be provided on the electric power supplying portion, and the horizontal movement of the electric power supplying portion may be controlled such that the electric power supplying portion moves along the mark, based on the mark detection results by the sensor.

Also, in the description above, if a plurality of vehicles 16 that are waiting to be charged are parked in the parking lot 12, after one vehicle 16 finishes charging, another vehicle 16 starts to be charged. However, the invention is not limited to this. For example, the vehicle to be charged may be switched each time charging has been performed for fixed period of time or each time the SOC of the secondary battery 18 increases a certain percentage, such that a plurality of vehicles 16 that are waiting to be charged and are parked in the parking lot 12 are charged evenly. Alternatively, control that charges until charging is complete may be combined with control that charges evenly. For example, if there is a vehicle 16 in which the period of time until the leaving time is equal to or less than a predetermined period of time, from among a plurality of vehicles 16 waiting to be charged, this vehicle 16 may be charged until charging is complete and the remaining plurality of vehicles 16 may be charged evenly.

Moreover, in the description above, only one electric power supplying portion 32 is provided, but the invention is not limited to this. For example, a plurality (though a smaller number than the number of vehicles that are able to be parked in the parking lot) of electric power supplying portions may also be provided.

The invention has been described with reference to example embodiments for illustrative purposes only. It should be understood that the description is not intended to be exhaustive or to limit form of the invention and that the invention may be adapted for use in other systems and applications. The scope of the invention embraces various modifications and equivalent arrangements that may be conceived by one skilled in the art.

1. A charging apparatus arranged in a parking lot provided with parking spaces for a plurality of vehicles, comprising:
at least one electric power supplying portion that is capable of supplying a vehicle parked in any one of the parking spaces with electric power for charging a secondary battery provided in the vehicle, while in a state in which a relative position of the electric power supplying portion with respect to the vehicle parked in one of the parking spaces is an electric power supplying position in which electric power can be supplied to the vehicle, and that is capable of moving between a plurality of first positions in which the relative position of the electric power supplying portion with respect to each vehicle, when a plurality of vehicles are parked in the plurality of parking spaces, parked in each of the parking spaces is the electric power supplying position, and a second position that is outside of a range in which that would interfere with a vehicle pulling into or out of the parking lot;
determining device for determining whether each vehicle parked in each parking space of the parking lot is an authorized vehicle that has been preregistered for the parking space in which the vehicle is parked;
detecting device for detecting a state of charge of the secondary battery for each vehicle parked in each parking space of the parking lot; and
controlling device for, when it is determined by the determining device that the vehicle parked in a given parking space of the parking lot is the authorized vehicle of the given parking space and the state of charge of the secondary battery of the vehicle detected by the detecting device is equal to or less than a predetermined value, performing control such that the electric power supplying portion moves to the first position corresponding to the given parking space, from among the plurality of first positions, and electric power is supplied by the electric power supplying portion to the vehicle parked in the given parking space.

2. The charging apparatus according to claim 1, further comprising a car stop that is arranged in each of the parking spaces of the parking lot, wherein the second position is a space, in the parking space, that is opposite a space where the vehicle can park and that is separated from the space where the vehicle can park by the car stop.

3. The charging apparatus according to claim 1, wherein the electric power supplying portion includes a base portion that can move within the parking lot, electric power supplying device that is mounted to the base portion, horizontal moving portion for moving the base portion in a horizontal direction and changing a direction of movement of the base portion within a horizontal plane, and raising/lowering portion for raising/lowering the electric power supplying device; and the controlling device first controls the horizontal moving portion to move the base portion to a horizontal position according to the first position that corresponds to the given parking space in which the vehicle is parked, and then controls the raising/lowering portion to raise/lower the electric power supplying device to the first position.

4. The charging apparatus according to claim 1, wherein the state in which the relative position of the electric power supplying portion with respect to the vehicle parked in one of the parking spaces is the electric power supplying position is a state in which the electric power supplying portion is in a position corresponding to an electric power receiving portion of the vehicle that is provided in a position offset to one end side in a vehicle longitudinal direction with respect to a center portion of the vehicle; the electric power supplying portion moves in a horizontal direction along a movement guiding portion arranged in the parking lot; the movement guiding portion is arranged along a section that extends from the second position to at least a position corresponding to the electric power receiving portion of the vehicle in one of the parking spaces when the vehicle is parked in the parking space of the parking lot while facing a first direction in which an end portion on the one end side in the vehicle longitudinal direction on which the electric power receiving portion is provided is closer to the second position than the end portion on the other end side; and with at least one of the parking spaces for a plurality of vehicles, the movement guiding portion extends to a position corresponding to the electric power receiving portion of the vehicle in one of the parking spaces when the vehicle is parked in the parking space while facing a second direction that is opposite the first direction.

5. The charging apparatus according to claim 1, wherein the controlling device positions the electric power supplying portion in the second position before a vehicle to be supplied with electric power by the electric power supplying portion arrives, by moving the electric power supplying portion to the second position when the vehicle has finished being supplied with electric power by the electric power supplying portion.

6. The charging apparatus according to claim 1, wherein the determining device includes a function of performing wireless communication with the vehicle; and the determining device determines whether the vehicle is the authorized vehicle of the parking space by comparing identification information of the vehicle received via wireless communication from the vehicle parked in the parking space of the parking lot with identification information of the authorized vehicle preregistered for the parking space.

7. The charging apparatus according to claim 1, wherein the detecting device includes a function of performing wireless communication with the vehicle; and the detecting device detects the state of charge of the secondary battery of the vehicle by receiving via wireless communication information indicating the state of charge of the secondary battery of the vehicle from the vehicle parked in the parking space of the parking lot.

8. The charging apparatus according to claim 1, wherein when there are a plurality of vehicles parked in the parking lot that are determined by the determining device to be authorized vehicles and in which the state of charge of the secondary battery detected by the detecting device is equal to or less than a predetermined value, the controlling device controls the electric power supplying portion to supply electric power to a plurality of vehicles to be supplied with electric power in order, according to an electric power supplying priority order for each authorized vehicle that has been preset based on at least one of an average parking lot leaving time of each authorized vehicle corresponding to a different parking spaces, among the parking spaces of the parking lot for a plurality of vehicles, an average running distance per charge of each authorized vehicle, and an average charging time per charge of each authorized vehicle.

9. The charging apparatus according to claim 1, wherein the controlling device includes a function of performing wireless communication with the vehicle; and when there are a plurality of vehicles parked in the parking lot that are determined by the determining device to be authorized vehicles and in which the state of charge of the secondary battery detected by the detecting device is equal to or less than a predetermined value, the controlling device i) obtains at least one of the state of charge of the secondary battery, a planned parking lot leaving time or an average parking lot leaving time, a running distance after the last charging or an average running distance per charge, and an average charging time per charge, ii) determines an order by which to supply electric power to a plurality of vehicles to be supplied with electric power based on the obtained information, and iii) controls the electric power supplying portion to supply electric power to the plurality of vehicles to be supplied with electric power in the determined order.

10. The charging apparatus according to claim 1, further comprising a plurality of notifying device, each of which is arranged at a residence of each owner of the authorized vehicle in each parking space of the parking lot and is connected via a communication wire to the controlling device and is capable of giving notice that charging is complete, wherein when electric power has finished being supplied to the vehicle by the electric power supplying portion, the controlling device controls the notifying device that is arranged at the residence of the owner of the vehicle for which electric power has finished being supplied to give notice that charging is complete.

11. The charging apparatus according to claim 1, further comprising:
electric power generating device for converting sunlight into electric power; and
electric power storing device for storing electric power that has been generated by the electric power generating device,
wherein the electric power supplying portion is connected to the electric power storing device, and supplies the electric power generated by the electric power generating device and stored in the electric power storing device to the vehicle.
